(19) United States
(12) Patent Application Publication
(10) Pub. No.: US 2013/0257593 A1
(43) Pub. Date: Oct. 3, 2013

(54) COMPUTER WITH LIGHT FAN AND DISPLAYING METHOD USING LIGHT FAN

(71) Applicant: TSUI-MING YANG, Tu-Cheng (TW)

(72) Inventor: TSUI-MING YANG, Tu-Cheng (TW)

(21) Appl. No.: 13/663,683

(22) Filed: Oct. 30, 2012

(30) Foreign Application Priority Data
Mar. 29, 2012 (TW) 101111205

(51) Int. Cl. G08B 5/22; G06F 1/20; G06F 1/16

(52) U.S. Cl. 340/6.1; 361/679.21; 361/679.26

(57) ABSTRACT

A computer includes a display and a host. The host includes a first hardware, a second hardware, a control chip, a first fan carrying LEDs, and a second fan carrying LEDs. The control chip includes a storing module, a control module, and a setting module. The control module obtains hardware information of the first hardware and the second hardware and stores the hardware information to the storing module. The setting module sets a display mode of the hardware information. The control module indicates at least some of the hardware information on the LEDs of the first and second fans according to the display mode.

### BACKGROUND

1. Technical Field

The disclosure generally relates to a computer with a light fan and a displaying method using the light fan.

2. Description of Related Art

A notebook computer has a battery. The notebook computer is powered by the battery. The operating system of the notebook computer can display the status of the battery, such as the quantity of electrical charge remaining, but the status of the battery can be seen only after the operating system has been booted.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a computer according to one embodiment of the present disclosure.

FIG. 2 is a schematic view of the light fan in the FIG. 1.

FIG. 3 is a schematic diagram of a computer according to one embodiment of the present disclosure.

FIG. 4 is a flow diagram of a displaying method according to one embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

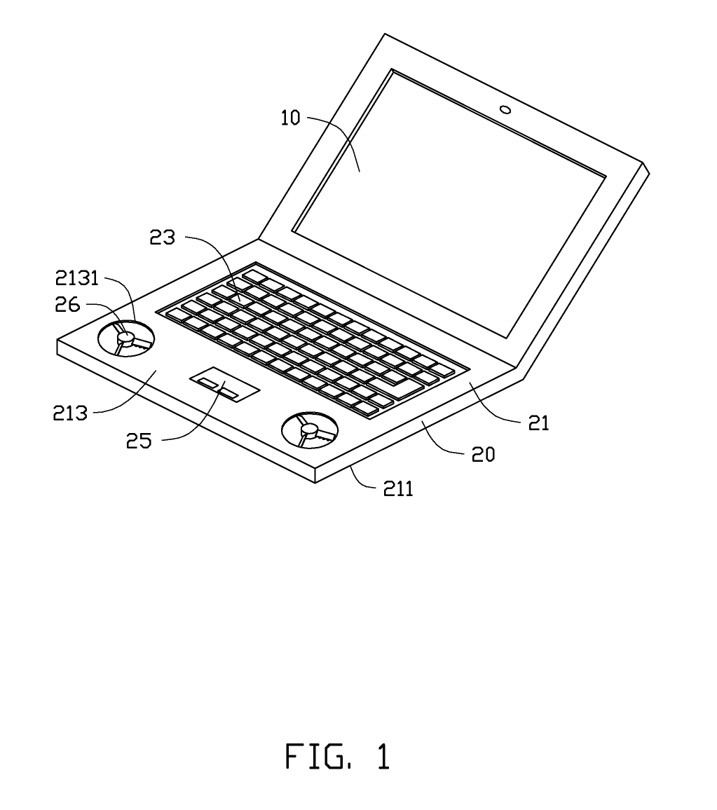

Referring to FIG. 1, a computer includes a display 10 and a host 20 pivotally connected to the display 10. The host 20 includes an enclosure 21 and a printed circuit board (not shown) mounted in the enclosure 21. In one embodiment, the computer is a notebook computer.

The enclosure 21 includes a bottom panel 211 and a top panel 213, substantially parallel to the bottom panel 211. The top panel 213 faces the display 10. The host 20 further includes a keyboard module 23 and a cursor module 25, mounted on the top panel 213. The top panel 213 defines two airflow openings 2131. The cursor module 25 is located between the two airflow openings 2131. The host 20 includes a light fan 26 in each airflow opening 2131.

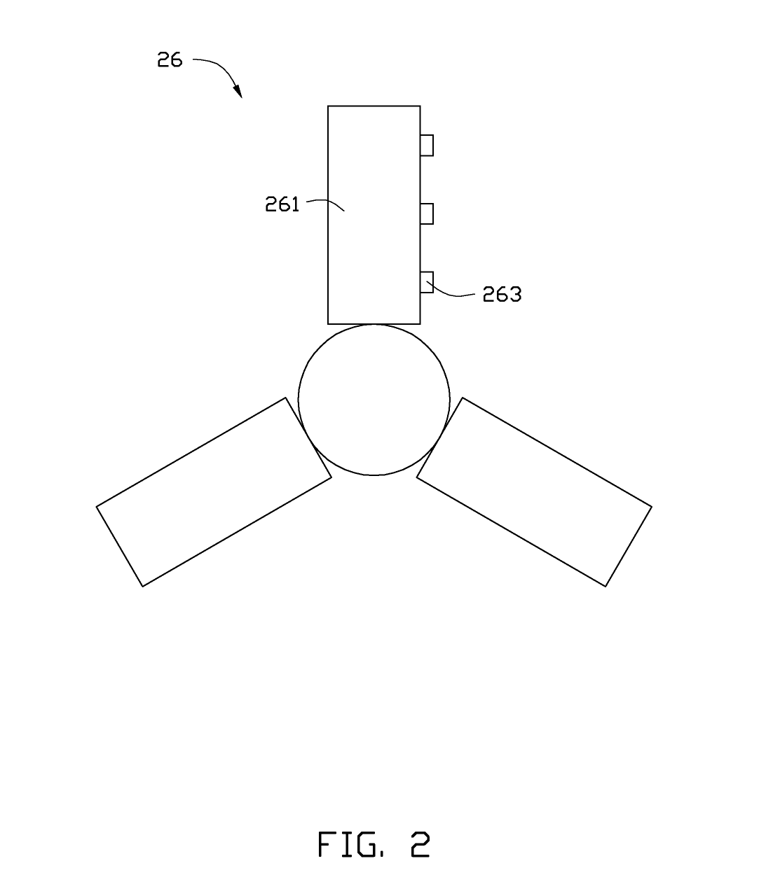

Referring to FIG. 2, each light fan 26 includes three fan blades 261. Each light fan 26 includes three light-emitting diodes (LEDs) 263 mounted to one of the three fan blades 261. The three LEDs 263 can indicate hardware information concerning the computer.

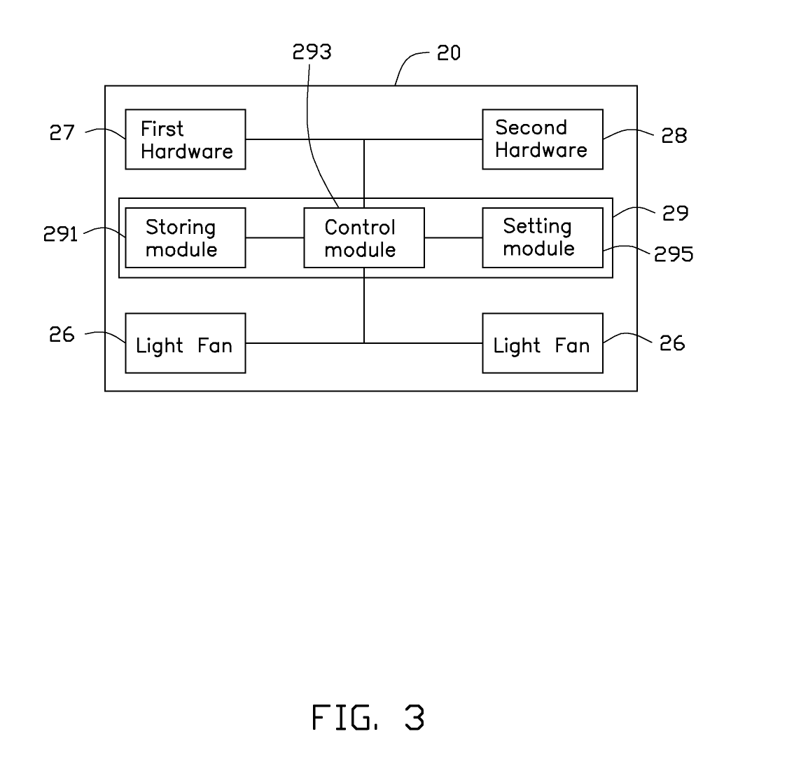

Referring to FIG. 3, the host 20 further includes a first hardware 27, a second hardware 28, and a control chip 29, which are all mounted in the enclosure 21. The control chip 29 includes a storing module 291, a control module 293, and a setting module 295. In one embodiment, the first hardware 27 is a battery, and the second hardware 28 is a central processing unit (CPU). The control module 293 is connected to the storing module 291 and the setting module 295. The light fans 26, the first hardware 27, and the second hardware 28 are connected to the control module 293.

The control module 293 obtains hardware information, such as quantity of electrical charge and remaining time of use of the first hardware 27, or temperature values of the second hardware 28. The control module 293 stores the hardware information to the storing module 291. The setting module 295 sets the display modes of the hardware information. For example, the setting module 295 may configure one of the two light fans 26 to display the quantity of electrical charge available and the other light fan 26 to indicate the time of use remaining of the first hardware 27. The setting module 295 can also set the configuration that one light fan 26 displays one of the quantity of electrical charge available and the remaining usage time of the first hardware 27 and the other light fan 26 displays the temperature values of the second hardware 28. The control module 293 provides hardware information by means of a visual indication on the light fans 26 according to the display mode.

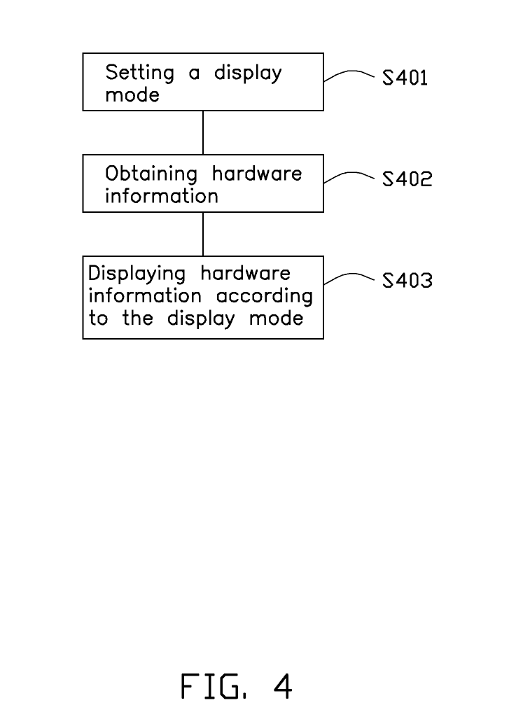

Referring to FIG. 4, a hardware information displaying method of one embodiment is shown as below.

S401, the setting module 295 of the host 20 sets the display mode.

S402, the control module 293 of the host 20 obtains hardware information from the first hardware 27 and the second hardware 28 and stores the hardware information in the storing module 291.

S403, the control module 293 of the host 20 displays hardware information according to the display mode.

In the above method, the light fan 26 also dissipates heat from the host 20 when displaying the hardware information.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A computer comprising:
a display; and
a host, the host comprises a first hardware, a second hardware, a control chip, a first light fan, and a second light fan; the control chip comprises a storing module, a control module, and a setting module; the control module is configured to obtain hardware information of the first hardware and the second hardware and store the hardware information to the storing module; the setting module is configured to set a display mode of the hardware information; and the control module is further configured to display at least some of the hardware information on the first light fan and the second light fan according to the display mode.

2. The computer of claim 1, wherein the display mode comprises the hardware information of the first hardware to be displayed on the first light fan and the hardware information of the second hardware to be displayed on the second light fan.

3. The computer of claim 1, wherein the first hardware is a battery; the hardware information of the first hardware comprises a quantity of electrical charge available and remaining usage time; and the display mode is that comprises the quantity of electrical charge available displayed on the first light fan and the remaining usage time displayed on the second light fan.

4. The computer of claim 1, wherein the computer is a notebook computer; the host comprises an enclosure receiving the first hardware, the second hardware, the control chip, the first light fan, and the second light fan; the enclosure comprises a top panel facing the display; and the top panel defines two airflow openings receiving the first light fan and the second light fan.

5. The computer of claim 4, wherein the host further comprises a cursor module mounted on the top panel, and the cursor module is located between the two airflow openings.

6. The computer of claim 4, wherein the host further comprises a keyboard module mounted on the top panel.

7. The computer of claim 1, wherein the first light fan comprises a plurality of fan blades, and one of the plurality of fan blades comprises a light emitting diode.

8. A displaying method of a computer comprising:
setting a display mode by a control chip of the computer;
obtaining hardware information of a first hardware and a second hardware of the computer by the control chip; and
displaying at least some of the hardware information on a first light fan and a second light fan of the computer according to the display mode by the control chip.

9. The displaying method of claim 8, wherein the display mode comprises the hardware information of the first hardware to be displayed on the first light fan and the hardware information of the second hardware to be displayed on the second light fan.

10. The displaying method of claim 8, wherein the first hardware is a battery; the hardware information of the first hardware comprises a quantity of electrical charge available and remaining usage time; and the display mode is that comprises the quantity of electrical charge available displayed on the first light fan and the remaining usage time displayed on the second light fan.
